(19) United States
(12) Patent Application Publication
(10) Pub. No.: US 2002/0135604 A1
(43) Pub. Date: Sep. 26, 2002

(54) Display drive circuit, semiconductor integrated circuit, display panel, and display drive method

(75) Inventor: Tsuyoshi Yoneyama, Fujimi-cho (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/062,422

(22) Filed: Feb. 5, 2002

(30) Foreign Application Priority Data
Feb. 7, 2001 (JP) 2001-30893
Feb. 1, 2002 (JP) 2002-25698

(51) Int. Cl. G09G 5/10

(52) U.S. Cl. 345/690

(57) ABSTRACT

The present invention provides a display drive circuit, a semiconductor integrated circuit, a display panel, and a display drive method that make it possible to broaden the types of colors that can be displayed and increase the degree of freedom of the selection of colors displayed, when displaying color in a plurality of grayscales. The system is provided with a RAM which sequentially stores data for image display; a plurality of grayscale pattern selection circuits, each selecting one grayscale pattern from among a plurality of grayscale patterns, based on data stored in the RAM; and a plurality of frame selection circuits which sequentially output grayscale patterns selected by the grayscale pattern selection circuits for a series of image frames.

Japanese Patent Application No. 2001-30893, filed on Feb. 7, 2001, and Japanese Patent Application No. 2002-25698, filed on Feb. 1, 2002 are hereby incorporated by reference in their entirety.

### BACKGROUND

The present invention relates to a display drive circuit, a semiconductor integrated circuit, a display panel, and a display drive method.

In a prior-art color LCD driver IC (a semiconductor integrated circuit: generally speaking, a display drive circuit) drives a color LCD, based on 8-bit image data (made up of three red (R) bits, three green (G) bits, and two blue (B) bits) that is output from an MPU. This is shown in FIG. 17.

Of image data D7 to D0 for one pixel that is input from the MPU, the three bits D7 to D5 represent eight grayscales of red, the three bits D4 to D2 represent eight grayscales of green, and the two bits D1 and D0 represent four grayscales of blue, as shown in FIG. 17. Image data of this format is used to display 256 colors (8×8×4 =256), by being input sequentially to a ROM within the driver IC, and then by being subjected to frame rate control (FRC) modulation.

In this prior-art color display method the number of colors that can be displayed is determined by the number of bits of image data that is input to the driver IC from the MPU. Since the number of bits of image data that is input to today's general-purpose color LCD driver ICs, the number of colors that can be displayed is limited to 256.

With 256 colors, however, it is not possible to represent subtle variations within similar colors. Recently, however, there are demands for increased numbers of colors in color displays.

Incidentally, Japanese Patent Application Laid-Open No. 63-318863 discloses a color image processing device having means for converting color image information into a plurality of color signals from analysis of a plurality of color analysis images, means for obtaining digital color signals with warping correction from that plurality of color signals, and color separation means for separating these digital color signals further into a plurality of color signals comprising a plurality of bits; wherein the configuration is such that a plurality of color separation means are provided as this color separation means for differentiating between the color signals to be output, and those color separation means can be exchanged. In an apparatus that provides color display using the four colors black, red, green, and blue, by way of example, it is simple to develop an apparatus that uses three colors for display, if it is made possible to separate them into three color signals for recording a color image. However, this color image processing device was not devised with the objective of increasing the number of colors that can be displayed.

Japanese Patent Application Laid-Open No. 10-327330 discloses a color recording device provided with a grayscale processing means that uses a threshold value table, which has a plurality of mutually different threshold values allocated to dot positions in unit grayscale processing regions that correspond to a plurality of recording dot positions, wherein recording is done at dot positions in accordance with recording color signals. This color recording device has a plurality of threshold value tables having mutually different threshold value matrices, means for selecting the threshold value table to be used in practice from those tables, a plurality of different signal correction processing function having mutually different details, and means for recording the details of signal correction processing corresponding to each type of threshold value table; wherein signal correction processing is based on details of the signal correction processing that corresponds the selected threshold value table. This is because it is difficult to perform sufficient correction during correction processing that has fixed processing details, since there can be differences in the levels of recording signals and in the details of the recording in practice, due to factors such as the amount of overlapping of colors. This color recording device was not devised with the objective of increasing the number of colors that can be displayed, because reproduced colors cannot be changed even if the operator switches the threshold value table.

Japanese Patent Application Laid-Open No. 60- 243735 discloses a color printer of the type in which color signals are converted by a color conversion table into print data and color printing is based on that print data, wherein the color printer is provided with a plurality of over-writable tables, the data stored in those tables can be set as desired, and also one of those tables is selected for use. However, this color printer requires the user to select one table from a plurality of tables to set the colors for printing, and thus it is not possible to increase the number of colors that can be displayed without having the user change the table.

### SUMMARY

According to one aspect of the present invention, there is provided a display drive circuit comprising:

RAM which sequentially stores data for image display that is input continuously;

a plurality of grayscale pattern selection circuits, each selecting one grayscale pattern from a plurality of grayscale patterns, based on data stored in the RAM; and

a plurality of frame selection circuits which are provided in correspondence with the plurality of grayscale pattern selection circuits, and sequentially output grayscale patterns selected by the plurality of grayscale pattern selection circuits for a series of image frames.

According to another aspect of the present invention, there is provided a display drive circuit comprising:

RAM which sequentially stores data for image display that is input continuously;

a plurality of FRCROMs which store a plurality of grayscale patterns with mutually different frame cycles, and use data stored in the RAM to select one grayscale pattern from among the plurality of grayscale patterns; and

a plurality of frame selection circuits each of which sequentially outputs the selected grayscale pattern selected by the FRCROMs, for each frame,

wherein a drive signal for driving a display portion is output based on the outputted grayscale pattern from the FRCROMS.

### BRIEF DESCRIPTION OF THE SEVERAL VIEWS OF THE DRAWING

FIG. 1 is a block diagram showing a semiconductor integrated circuit in accordance with one embodiment of the present invention.

FIG. 2 is a diagram showing the LCD panel of FIG. 1.

FIG. 3 is a block diagram showing an example of the configuration of the MPU interface.

FIG. 4A is a diagram for illustrating the operation of the MPU interface, and FIG. 4B is a timing chart showing an example of the operation timing of the MPU interface.

FIG. 5 is an example of the conversion table in the image data conversion circuit.

FIG. 6 is a block diagram showing an example of the configuration of the image data conversion circuit.

FIG. 7 shows examples of grayscale patterns stored in an FRCROM.

FIG. 8 is a table showing 32 grayscales that can be expressed by the 32 grayscale patterns stored in the FRCROM.

FIG. 9 is a graph showing the continuity of the 32 grayscales of FIG. 8.

FIG. 10 is a schematic block diagram showing connective relationships between the components of the IC driver according to one embodiment of the present invention.

FIG. 11 is a diagram for illustrating address signals that are output from the display control circuit.

FIG. 12 is a schematic block diagram of connective relationships between the FRCROMs, frame selection circuits, and the display control circuit.

FIG. 13 is a circuit diagram of an example of the configuration of the frame selection circuits.

FIG. 14 is a circuit diagram showing the configuration of a ROM including the grayscale pattern selection ROMs and FRCROMs.

FIG. 15 is a block diagram showing an example of the configuration of the LCD interface.

FIG. 16 is a diagram showing an example of the configuration of the display panel.

FIG. 17 is a diagram for illustrating the data processing in accordance with a prior-art color display method.

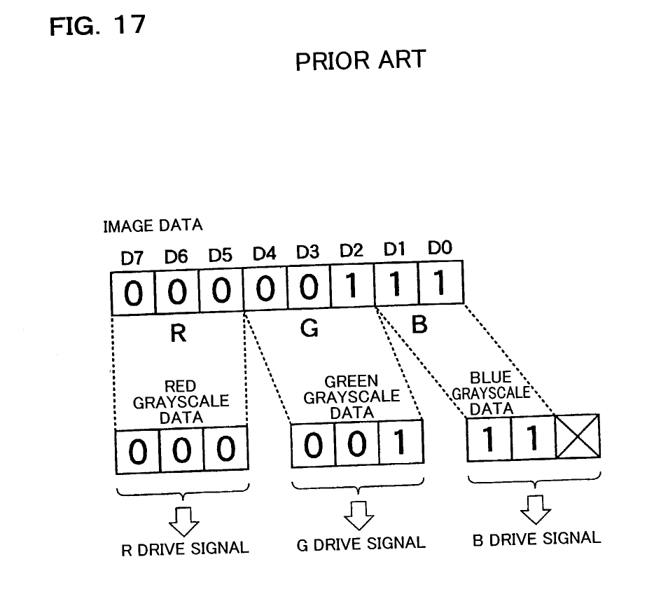

### DETAILED DESCRIPTION

Embodiments of the present invention devised in the light of the above described technical problems may provide a display drive circuit and a semiconductor integrated circuit that make it possible to broaden the types of colors that can be displayed and increase the degree of freedom of the selection of colors displayed, when driving an LCD or the like to display color in a plurality of grayscales, and also to a display panel and display drive method using the same.

This embodiment is described below.

Note that the embodiments described below do not in any way limit the scope of the present invention defined by the claims as laid out herein. In addition, all the elements of the embodiments described below should not be taken as essential requirements of the present invention.

According to one embodiment of the present invention, there is provided a display driver circuit comprising:

RAM which sequentially stores data for image display that is input continuously;

a plurality of grayscale pattern selection circuits, each selecting one grayscale pattern from a plurality of grayscale patterns, based on data stored in the RAM; and

a plurality of frame selection circuits which are provided in correspondence with the plurality of grayscale pattern selection circuits, and sequentially output grayscale patterns selected by the plurality of grayscale pattern selection circuits for a series of image frames.

This display drive circuit may further comprise an image data conversion circuit which receives data in which grayscales are represented by N bits (where N is an integer greater than or equal to 2), converts the received data into data in which grayscales are represented by M bits (where M is an integer such that M>N), based on a set command, and supplies the converted data to the RAM.

In this display drive circuit, each of the grayscale pattern selection circuits may include: a selection ROM which outputs a grayscale pattern selection signal based on data stored in the RAM; and an FRCROM which selects one grayscale pattern from among the plurality of grayscale patterns in accordance with the outputted grayscale pattern selection signal, and uses the selected grayscale pattern to perform frame rate control (FRC) modulation in accordance with a control signal that is output from the corresponding frame selection circuit.

In the display drive circuit, each of the frame selection circuits may be divided into a plurality of portions that are disposed on either side of the corresponding grayscale pattern selection circuit.

In other words, a circuit pattern which includes a plurality of frame selection circuits each divided into a plurality of portions, could be disposed on either side of the grayscale pattern selection circuits.

The above described configuration makes it possible to broaden the types of colors that can be displayed and increase the degree of freedom of the selection of colors displayed, by switching and outputting the grayscale patterns stored in the plurality of frame selection circuits in accordance with the image data.

According to one embodiment of the present invention, there is provided a display drive circuit comprising:

RAM which sequentially stores data for image display that is input continuously;

a plurality of FRCROMs which store a plurality of grayscale patterns with mutually different frame cycles, and use data stored in the RAM to select one grayscale pattern from among the plurality of grayscale patterns; and

a plurality of frame selection circuits each of which sequentially outputs the selected grayscale pattern selected by the FRCROMs, for each frame,

wherein a drive signal for driving a display portion is output based on the outputted grayscale pattern from the FRCROMS.

If it is assumed that the plurality of FRCROMs in this case are first to kth FRCROMs (where k is an integer greater than or equal to 2), the first FRCROM stores a plurality of grayscale patterns having a first frame cycle. The second FRCROM stores a plurality of grayscale patterns having a second frame cycle that differs from the first, and third to kth frame cycles. The kth FRCROM stores a plurality of grayscale patterns having a kth frame cycle that differs from the first to (k-1)th frame cycles.

Since this embodiment makes it possible to select one grayscale pattern from a plurality of grayscale patterns having a plurality of frame cycles, to drive the display portion, it enables a fine grayscale display, even when the image data has a small number of bits.

This display drive circuit may further comprise an image data conversion circuit which receives data in which grayscales are represented by N bits (where N is an integer greater than or equal to 2), converts the received data into data in which grayscales are represented by M bits (where M is an arbitrarily settable integer such that M>N), and supplies the converted data to the RAM, wherein each of the frame selection circuits outputs the selected grayscale pattern based on the M-bit grayscales, for each frame.

This configuration makes it possible to broaden the types of colors that can be displayed, even if the number of bits in the image data is small, and also enables the implementation of grayscale representation in accordance with grayscale characteristics.

A semiconductor integrated circuit in accordance with one embodiment of the present invention comprises any of the above described display drive circuits, and a terminal which outputs a drive signal generated on the basis of the selected grayscale pattern.

This configuration makes it possible to provide an IC that performs a fine grayscale display, even when the image data has a small number of bits.

A display panel in accordance with one embodiment of the present invention comprises: pixels specified by a plurality of common electrodes and a plurality of segment electrodes, which mutually intersect; and any of the above described display drive circuits, which drives the segment electrodes.

This configuration makes it possible to provide a display panel that can perform a fine grayscale display, even when the image data has a small number of bits. In such a case, the scan driver that drives the common electrodes could be provided outside the display panel or it could be provided on the substrate on which the display panel is formed.

A display drive method in accordance with one embodiment of the present invention comprises: selecting one grayscale pattern from among a plurality of grayscale patterns having at least two types of frame cycles, based on data for image display, and outputting the selected grayscale pattern for each frame; and outputting a drive signal for driving a display portion, based on the selected grayscale pattern.

This configuration makes it possible to perform a fine grayscale display, even when the image data has a small number of bits, because the configuration is such that one grayscale pattern is selected from a plurality of grayscale patterns having different frame cycles, to drive the display portion.

This display drive method may further comprise: converting grayscales of N bits (where N is an integer greater than or equal to 2) into grayscales of M bits (where M is an arbitrarily settable integer such that M>N); and selecting one grayscale pattern from among the plurality of grayscale patterns having at least two types of frame cycles, based on the M-bit grayscales, and outputting the selected grayscale pattern for each frame.

This method makes it possible to broaden the types of colors that can be displayed, even if the number of bits in the image data is small, and also enables the implementation of grayscale representation in accordance with grayscale characteristics.

These embodiments are described below with reference to the accompanying figures.

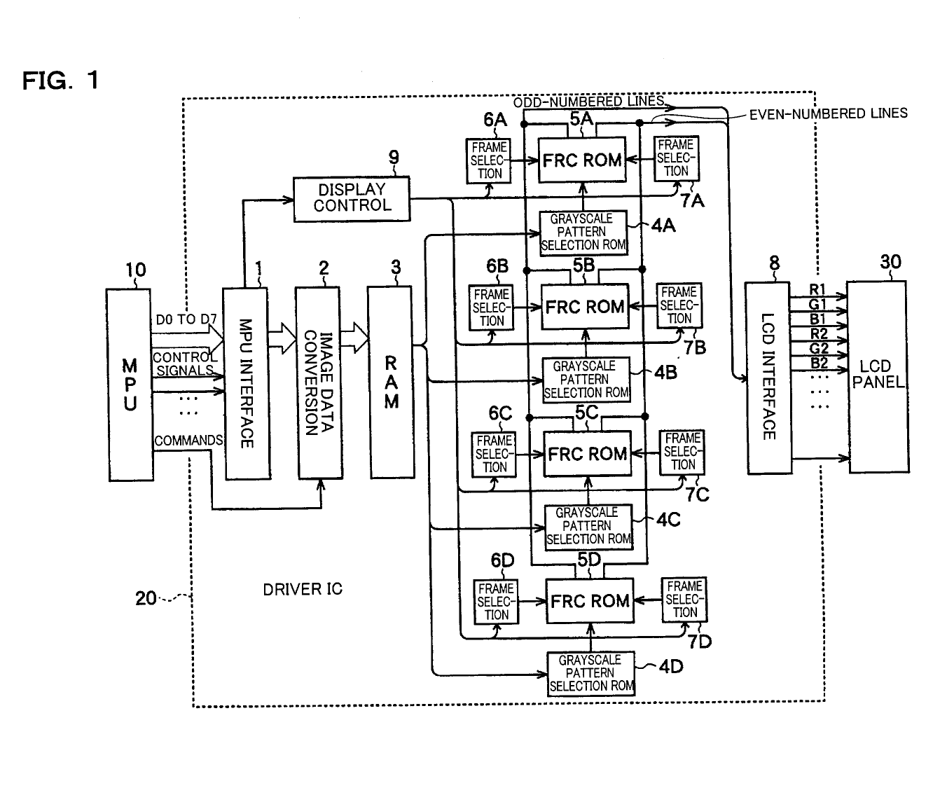

The configuration of a semiconductor integrated circuit in accordance with an embodiment of the present invention is shown in FIG. 1. In this case, the display drive circuit is described with reference to a case in which it is used as a semiconductor integrated circuit in a driver IC for a color LCD.

As shown in FIG. 1, 8-bit image data D7 to D0 that represents image information for each pixel is input sequentially to an MPU 10 in a driver IC (semiconductor integrated circuit) 20. Various control signals including a write control signal and a read control signal are also input to the driver IC 20. The driver IC 20 generates a plurality of groups of R, G, and B drive signals, based on this image data and the control signals, and outputs them respectively to a plurality of segment electrodes of an LCD panel (generally speaking: a display panel) 30.

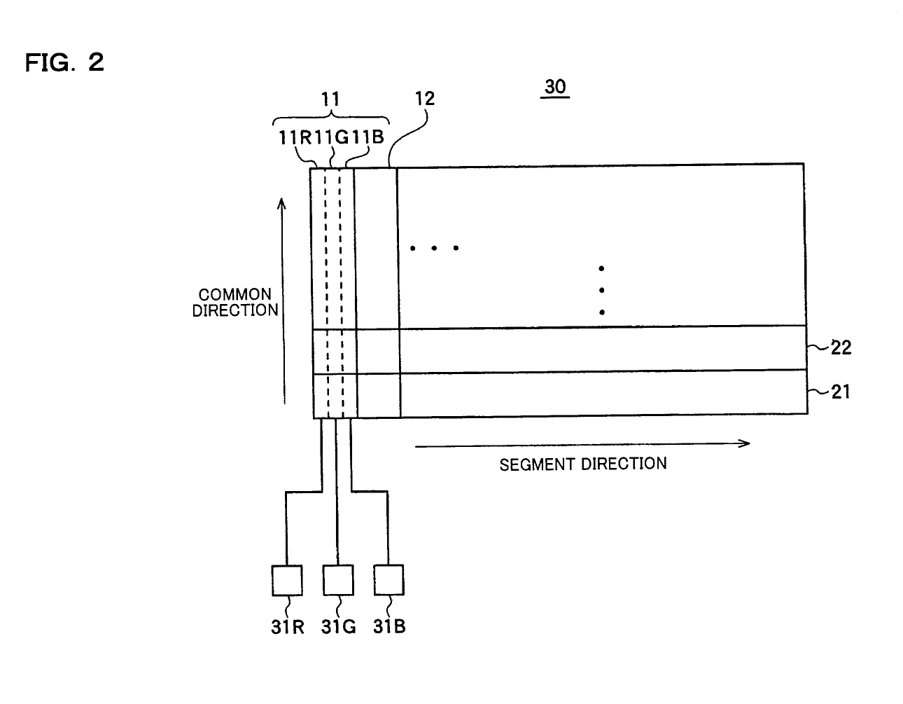

The configuration of the LCD panel is shown schematically in FIG. 2. The LCD panel 30 has a plurality of regions 11, 12, . . . in the segment direction and a plurality of regions 21, 22, . . . in the common direction. In this case, each pixel is specified by specifying one region in the segment direction and one region in the common direction. The LCD panel 30 could have 160 regions in the segment direction and 120 regions in the common direction, by way of example. In such a case, the LCD panel 30 has 160×120 pixels.

Each region in the segment direction is further subdivided into three regions (dots) 11R, 11G, and 11B, and terminals 31R, 31G, and 31 Bare connected to three corresponding elements for applying voltages to those regions.

Returning to FIG. 1, the driver IC 20 also comprises an MPU interface 1 for connection to the MPU 10 and an LCD interface 8 for connection to the LCD panel 30. Drive signals that are output from the LCD interface 8 are output through terminals to the segment electrodes of the LCD panel 30. This causes each of the RGB regions to be driven in the segment electrodes of the LCD panel 30.

The driver IC 20 stores a plurality of grayscale patterns for at least two types of frame cycle. One grayscale pattern that is selected from this plurality of grayscale patterns is output sequentially for each frame, based on image data that is input through the MPU interface 1. This enables the driver IC 20 to provide grayscale display by adjusting the frame rate control (FRC).

Within the driver IC 20, image data from the MPU interface 1 is supplied to an image data conversion circuit 2 and control signals that are output from the MPU interface 1 are supplied to a display control circuit 9. The image data conversion circuit 2 converts the input image data into data of a larger number of bits, in accordance with commands supplied from the MPU 10. For example, the image data conversion circuit 2 could convert 8-bit image data (made up of three red (R) bits, three green (G) bits, and two blue (B) bits) into red grayscale data, green grayscale data, and blue grayscale data where each color is expressed by four or five bits of grayscale data.

If the image data is converted into 4-bit grayscale data, it becomes possible to set (2⁴)³ =4096 different colors, and thus display 256 or 4096 different colors therefrom, depending on the image data. If the image data is converted into 4-bit data, furthermore, it becomes possible to set (2⁵)³=approximately 320,000 colors, and thus display 256, 4096, or 320,000 different colors therefrom, depending on the image data. Note that it does not matter if image data having eight or more bits is input to the image data conversion circuit 2, since the configuration could equally well be one in which image data having four, five, or more bits for each color is input directly to the driver IC 20.

The description below relates to the fetching of image data that expresses grayscales by four bits for each color, which is then converted into 5-bit grayscale data for each color.

The description first concerns the MPU interface 1. The MPU interface 1 is capable of writing 4-bit image data, which has been written in 8-bit units by the MPU 10, in 24-bit (2-pixel) units into a RAM 3.

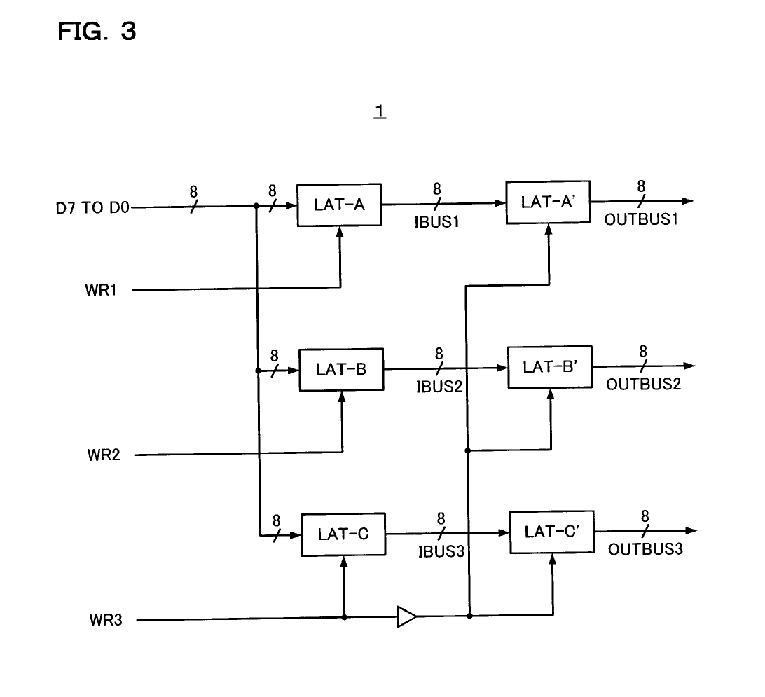

An example of the configuration of the MPU interface 1 is shown in FIG. 3.

The MPU interface 1 comprises latch circuits LAT-A to LAT-C and latch circuits LAT-A′ to LAT-C′. The latch circuits LAT-A to LAT-C latch the 8-bit image data D7 to D0 that is input from the MPU 10. The latch circuits LAT-A′ to LAT-C′ latch the data that has been latched by the latch circuits LAT-A to LAT-C.

The latch circuit LAT-A bases the latching of the 8-bit image data D7 to D0 on a write control signal WR1. Similarly, the latch circuit LAT-B bases the latching of the 8-bit image data D7 to D0 on a write control signal WR2. Furthermore, the latch circuit LAT-C bases the latching of the 8-bit image data D7 to D0 on a write control signal WR3. The data that has been latched by the latch circuits LAT-A to LAT-C is output to internal buses IBUS1 to IBUS3.

The latch circuits LAT-A′ to LAT-C′ latch the data on the internal buses IBUS1 to IBUS3, based on a write delay control signal that delays the write control signal WR3, and outputs it to corresponding output buses OUTBUS1 to OUTBUS3.

In general, if image data in which grayscales are expressed as four bits for each color is written in 8-bit units, the grayscale data for one pixel is written by two write operations. It is therefore necessary to perform a further two writes when writing the grayscale data for the second pixel subsequently.

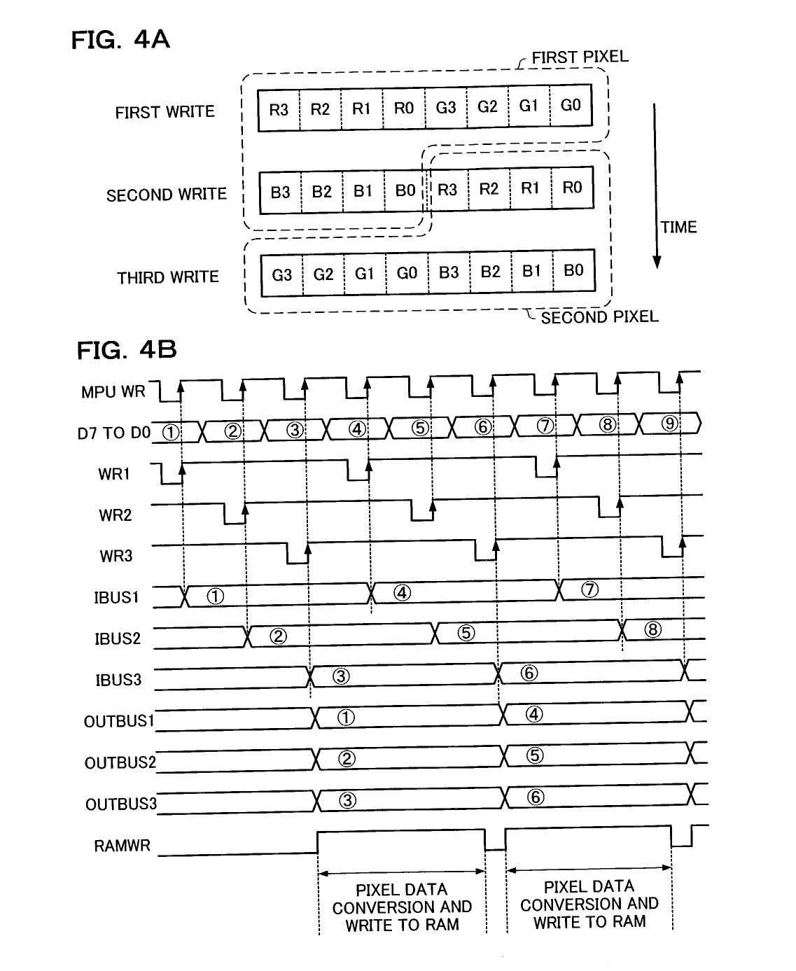

That is why the driver IC 20 is provided with the latch circuits LAT-A to LAT-C as shown in FIG. 3, so that grayscale data for two pixels is latched by three write operations, as shown in FIG. 4. The grayscale data for the two pixels is latched by the latch circuits LAT-A′ to LAT-C′ in synchronization with the third write operation, then is supplied to the later-stage image data conversion circuit 2.

For that reason, the write control signals WR1 to WR3 go active in sequence every time a write control signal MPUWR from the MPU 10 goes active, as shown in FIG. 4B, to fetch the image data D7 to D0 into the latch circuits. The latch circuits LAT-A′ to LAT-C′ latch the data on the internal buses IBUS1 to IBUS3 (in synchronization with the write control signal WR3) by a write delay control signal that has been delayed from the write control signal WR3 in order to ensure a set-up time and a hold time. The configuration is such that the process of converting the number of bits and writing to the RAM 3 is done during the period in which the data is being output to the output buses OUTBUS1 to OUTBUS3.

This makes it possible to reduce the number of write operations performed on the image data by the MPU 10, thus making it possible to efficiently fetch image data that is being input continuously.

The 4-bit image data for each color that has been fetched efficiently in this manner by the MPU interface 1 is input to the image data conversion circuit 2. The image data conversion circuit 2 converts the 4-bit image data (N=4) into grayscale data of any settable number of bits, such as 5-bit grayscale data (M=5).

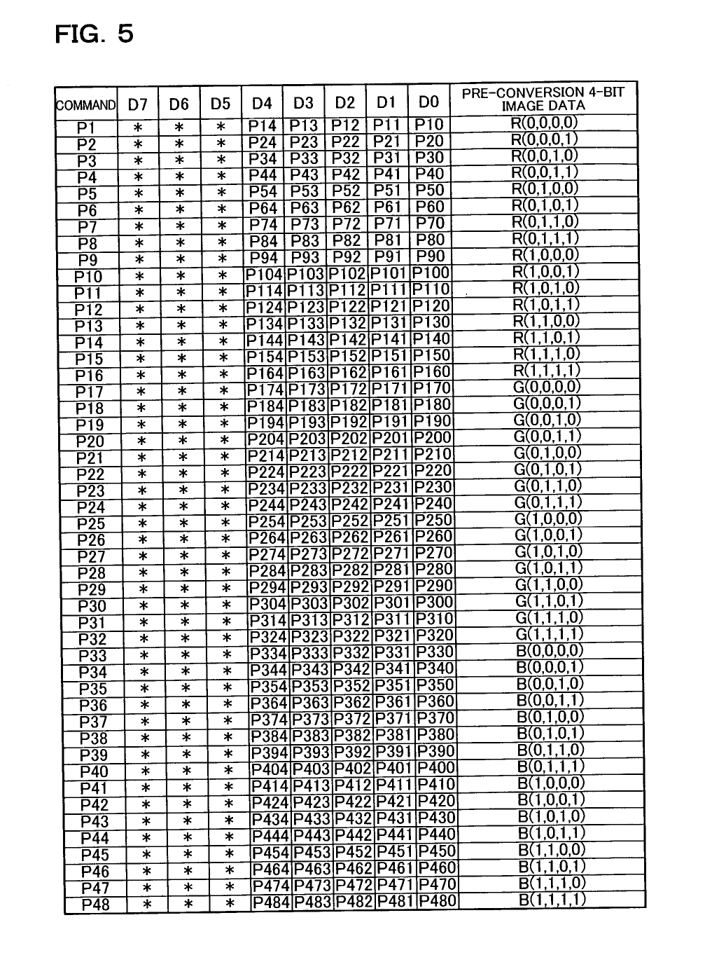

An example of the conversion table generated by the image data conversion circuit 2 is shown in FIG. 5.

In this case, the description concerns the conversion of 4 -bit image data for each color to 5-bit grayscale data for each color, but there is no limit on the number of bits in the grayscale data after the conversion.

This type of conversion table comprises a plurality of latch circuits. The configuration is such that the 5-bit grayscale data to be converted from 4-bit image data can be set with respect to these latch circuits by commands Px (where x=1 to 48) from the MPU 10, by way of example. If 5-bit grayscale data to be converted is set for 4-bit image data R (0,0,0,0), by way of example, a command P1 is issued from the MPU 10. On receiving the command P1, the image data conversion circuit 2 stores 5-bit grayscale data P14 to P10, after conversion from the data D4 to D0. When R (0,0,0,0) is input as 4-bit image data subsequently, the configuration is such that the image data conversion circuit 2 outputs the 5-bit grayscale data P14 to P10.

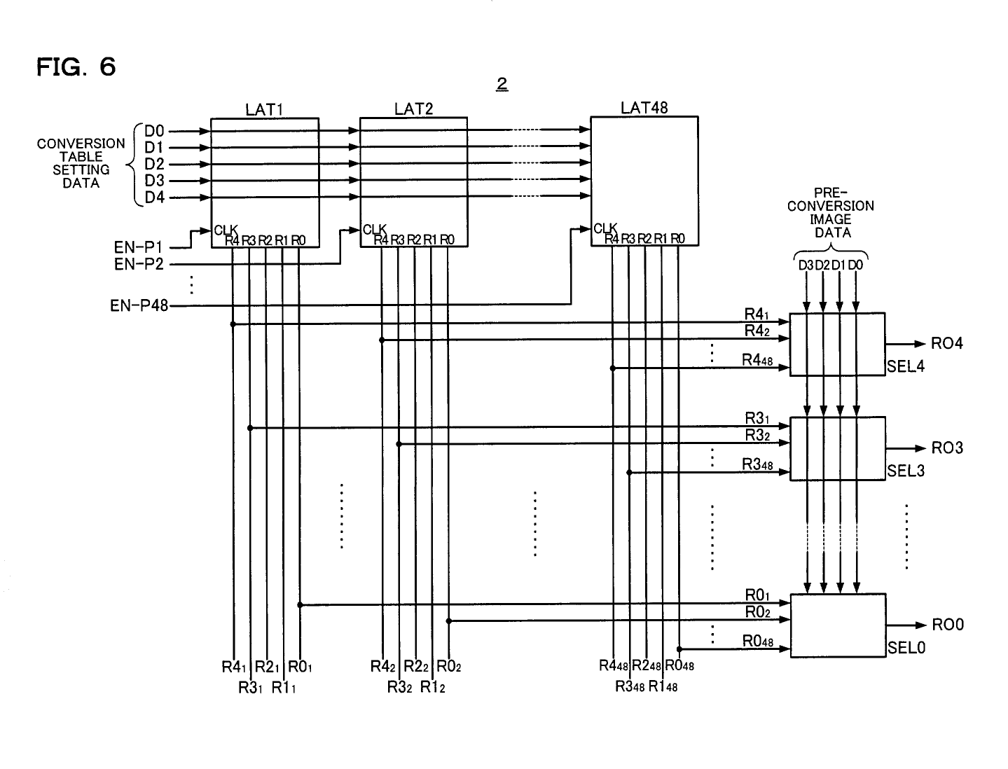

An example of the configuration of the image data conversion circuit 2 is shown in FIG. 6.

In this case, only the portion for converting the red (R) image data is shown.

The image data conversion circuit 2 comprises 5-bit latch circuits LAT1 to LAT48 and selector circuits SEL0 to SEL4.

The latch circuits LAT1 to LAT48 input the data D4 to D0 for conversion table setting. The latch circuit LAT1 latches the data D4 to D0 for conversion table setting, based on an enable signal EN-P1 that goes active when the command P1 is input from the MPU 10. The latch circuit LAT2 latches the data D4 to D0 for conversion table setting, based on an enable signal ENP2 that goes active when the command P2 is input from the MPU 10. Similarly, the latch circuits LAT3 to 48 each latch the data D4 to D0 for conversion table setting, based on enable signals EN-P3 to EN-P48 that go active when the corresponding command P3 to P48 is input from the MPU 10.

The latch circuits LAT1 to LAT48 output latched 5-bit conversion table data R4₁ to R0₁, R4₂ to R0₂, . . . , to R4₄₈ to R0₄₈.

The selector circuit SEL0 selects a selection bit RO0 for output, based on the pre-conversion 4-bit image data D3 to D0 that has been output from the MPU interface 1, from among the conversion table data R0₁ to R0₄₈ output from the corresponding latch circuits LAT1 to LAT48.

The selector circuit SEL1 selects a selection bit RO1 for output, based on the pre-conversion 4-bit image data D3 to D0 that has been output from the MPU interface 1, from among the conversion table data R1₁ to R1₄₈ output from the corresponding latch circuits LAT1 to LAT48.

The selector circuit SEL2 selects a selection bit RO2 for output, based on the pre-conversion 4-bit image data D3 to D0 that has been output from the MPU interface 1, from among the conversion table data R2₁ to R2₄₈ output from the corresponding latch circuits LAT1 to LAT48.

The selector circuit SEL3 selects a selection bit RO3 for output, based on the pre-conversion 4-bit image data D3 to D0 that has been output from the MPU interface 1, from among the conversion table data R3₁ to R3₄₈ output from the corresponding latch circuits LAT1 to LAT48.

The selector circuit SEL3 selects a selection bit RO4 for output, based on the pre-conversion 4-bit image data D3 to D0 that has been output from the MPU interface 1, from among the conversion table data R4₁ to R4₄₈ output from the corresponding latch circuits LAT1 to LAT48.

when the 4-bit image data D3 to D0 is (0,0,0,0), by way of example, the selector circuits SEL0 to SEL4 select R41 to R01 that are set in the latch circuit LAT1 and output therefrom, based on the command P1, as the selection bits R4₁ to R0₁.

The above described configuration makes it possible for the image data conversion circuit 2 to output the selection bits RO4 to RO0 as 5-bit grayscale data, from the pre-conversion 4-bit image data D4 to D0.

The grayscale data that is output continuously from the image data conversion circuit 2 in this manner is sequentially stored in the RAM 3. Grayscale pattern selection ROMs 4A to 4D are connected to the RAM 3. Each of the grayscale pattern selection ROMs 4A to 4D outputs a grayscale pattern selection signal for selecting one grayscale pattern from a plurality of grayscale patterns stored in FRCROMs 5A to 5D, based on grayscale data (assumed to be 5 bits hereinafter) for each color that is supplied from the RAM 3.

In this case, a grayscale pattern is a pattern that specifies whether a given frame cycle is on or off, in order to provide grayscale representation corresponding to a grayscale. The FRCROMs 5A to 5D store a plurality of grayscale patterns corresponding to grayscales having mutually different frame cycles.

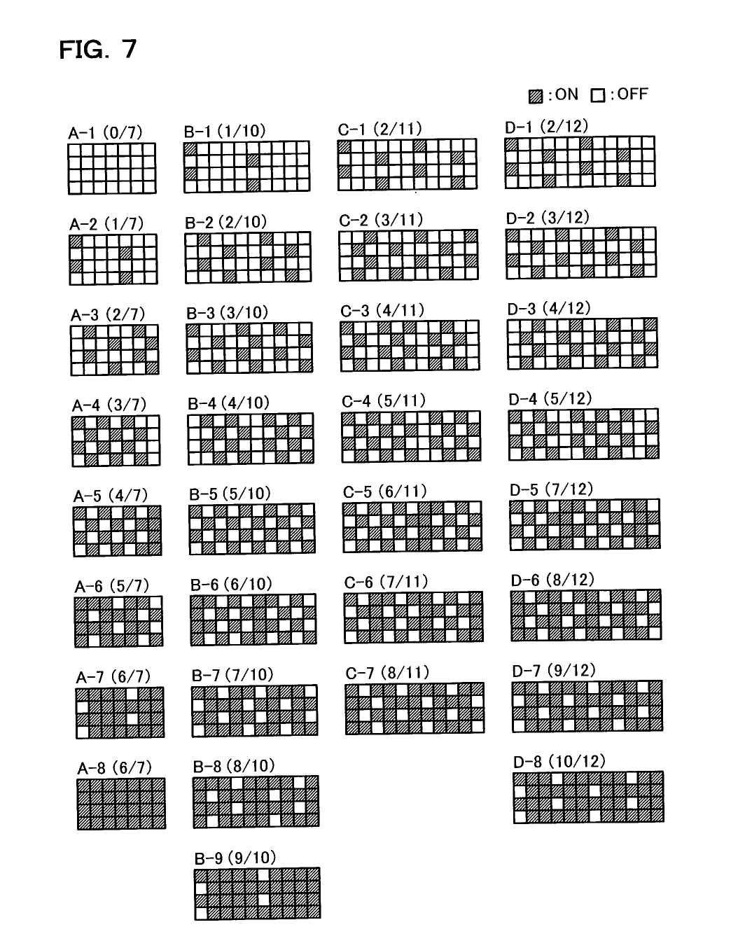

Examples of grayscale patterns stored in the FRCROMs 5A to 5D are shown in FIG. 1. Eight grayscale patterns from grayscale pattern A-1 to A-8 are stored in the FRCROM 5A, and one is selected therefrom, based on the grayscale data. Similarly, nine grayscale patterns from grayscale pattern B-1 to B-9 are stored in the FRCROM 5B, seven grayscale patterns from grayscale pattern C-1 to C-7 are stored in the FRCROM 5C, and eight grayscale patterns from grayscale pattern D-1 to D-8 are stored in the FRCROM 5D. These grayscale patterns are preferable shifted by one pattern for each output. For example, the ROM data is generated shifted by one step at a time along the side in FIG. 7, for one segment output. Note that the start address of each grayscale pattern is exactly the same within one frame period.

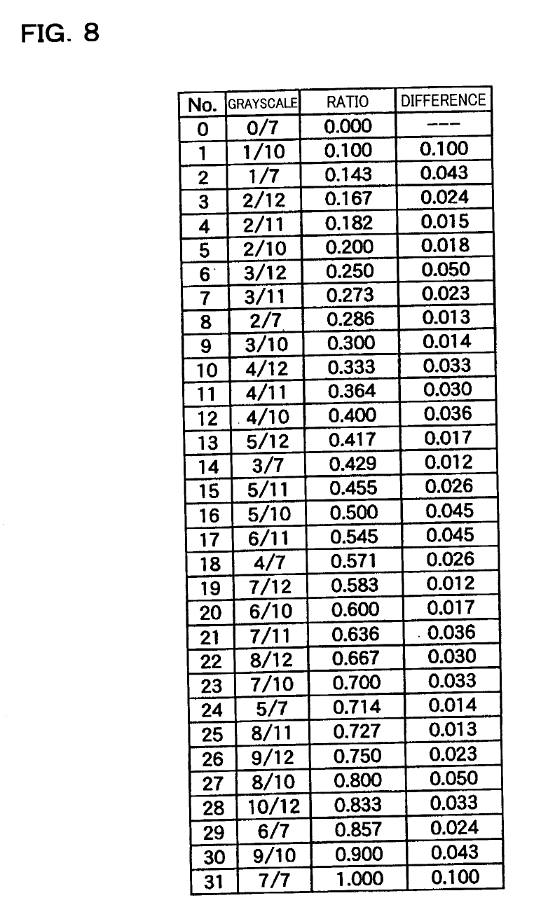

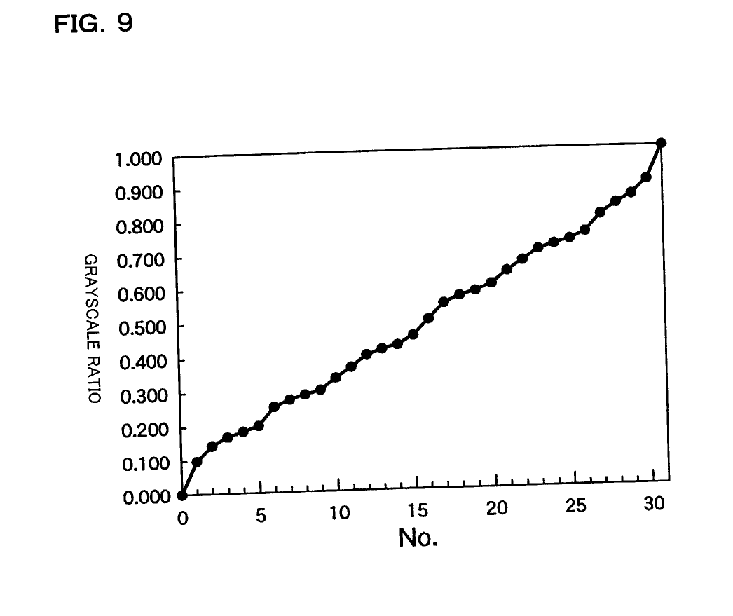

By using the total of 32 different grayscale patterns stored in the FRCROMs 5A to 5D, it becomes possible to represent each RGB color in 32 grayscales, as shown in FIG. 8. The continuity of these grayscales is shown in FIG. 9. As shown in FIG. 9, this embodiment enables a grayscale display of a finer grain than the prior-art eight-grayscale display.

This enables simple implementation within the image data conversion circuit 2, by setting a conversion table in such a manner that the 4-bit image data for each color that is input from the MPU 10 is converted into 5-bit image data for each color corresponding to each grayscale, as shown in FIGS. 8 and 9.

In addition, frame selection circuits 6A to 6D and 7A to 7D are also connected to the FRCROMs 5A to 5D, respectively, as shown in FIG. 1. The frame selection circuits 6A to 6D and 7A to 7D adjust the frame rate control (FRC) for a series of image frames under the control of the display control circuit 9, by causing sequential output of grayscale patterns selected from the FRCROMs 5A to 5D.

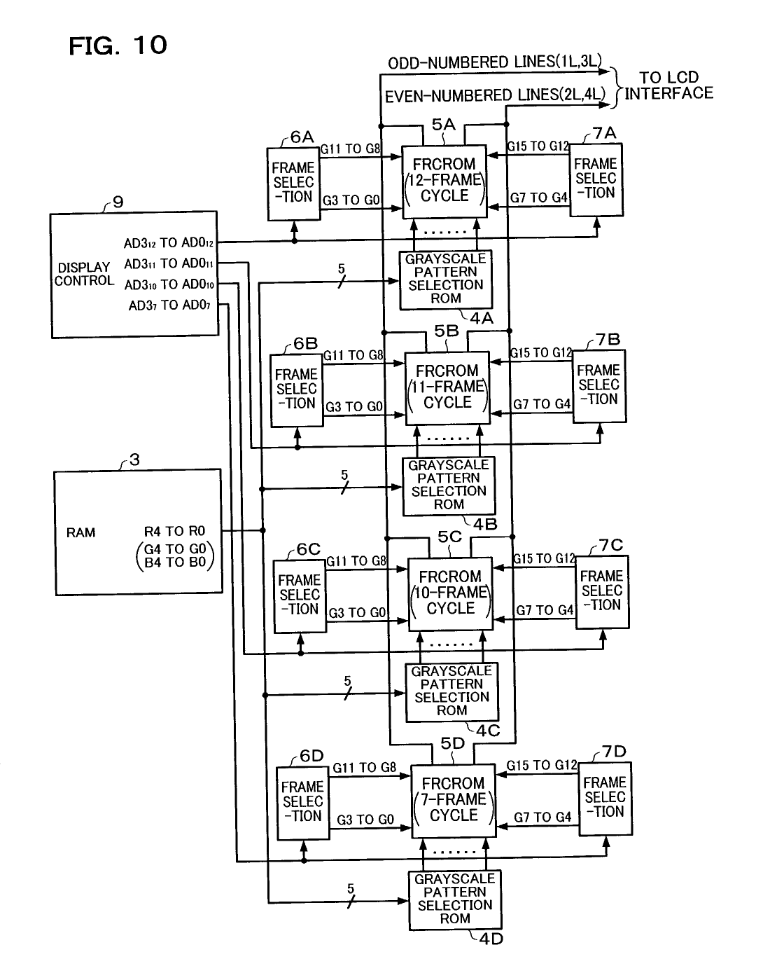

The connective relationships between the RAM 3, the grayscale pattern selection ROMs 4A to 4D, the FRCROMs 5A to 5D, the frame selection circuits 6A to 6D and 7A to 7D, and the display control circuit 9 within the driver IC 20 are shown schematically in FIG. 10.

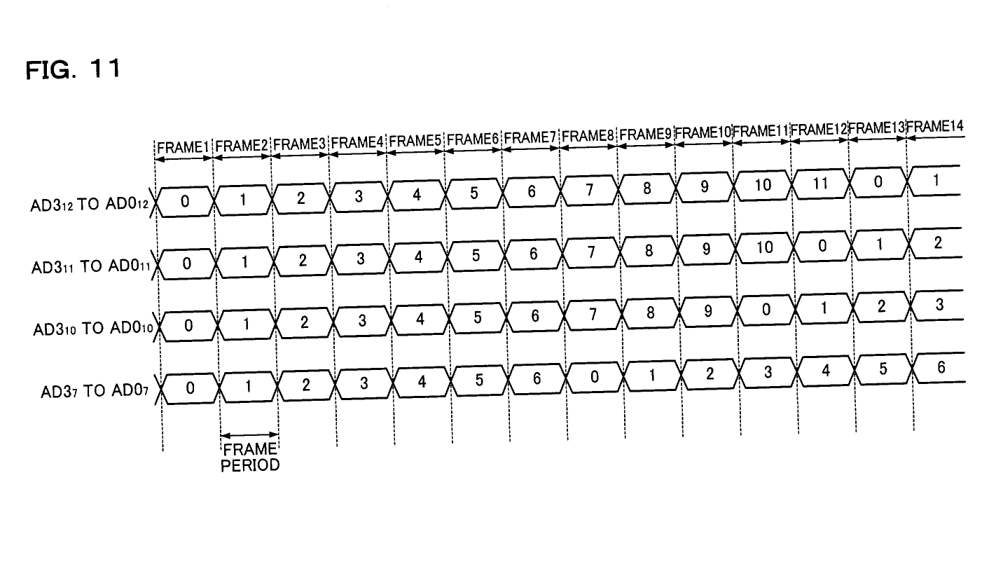

The display control circuit 9 outputs address signals AD3₁₂ to AD0₁₂ to the frame selection circuits 6A and 7A. The address signals AD3₁₂ to AD0₂ are configured to indicate frame numbers that are updated every time a frame period expires, and repeat in a 12-frame cycle, as shown in FIG. 11.

The display control circuit 9 also outputs AD3₁₁ to AD0₁₁ to the frame selection circuits 6B and 7B. The address signals AD3₁₁ to AD0₁₁ are configured to indicate frame numbers that are updated every time a frame period expires, and repeat in an 11-frame cycle, as shown in FIG. 11.

The display control circuit 9 also outputs address signals AD3₁₀ to AD0₁₀ to the frame selection circuits 6C and 7C. The address signals AD3₁₀ to AD0₁₀ are configured to indicate frame numbers that are updated every time a frame period expires, and repeat in a 10-frame cycle, as shown in FIG. 11.

The display control circuit 9 also outputs address signals AD3₇ to AD0₇ to the frame selection circuits 6D and 7D. The address signals AD3₇ to AD0₇ are configured to indicate frame numbers that are updated every time a frame period expires, and repeat in a 7-frame cycle, as shown in FIG. 11.

The RAM 3 outputs the 5-bit grayscale data R4 to RO that has been converted by the image data conversion circuit 2, to the grayscale pattern selection ROMs 4A to 4D.

The grayscale pattern selection ROMs 4A to 4D output grayscale pattern selection signals for selecting the one grayscale pattern among the plurality of grayscale patterns stored in the FRCROMs 5A to 5D, in accordance with grayscales based on the 5-bit grayscale data.

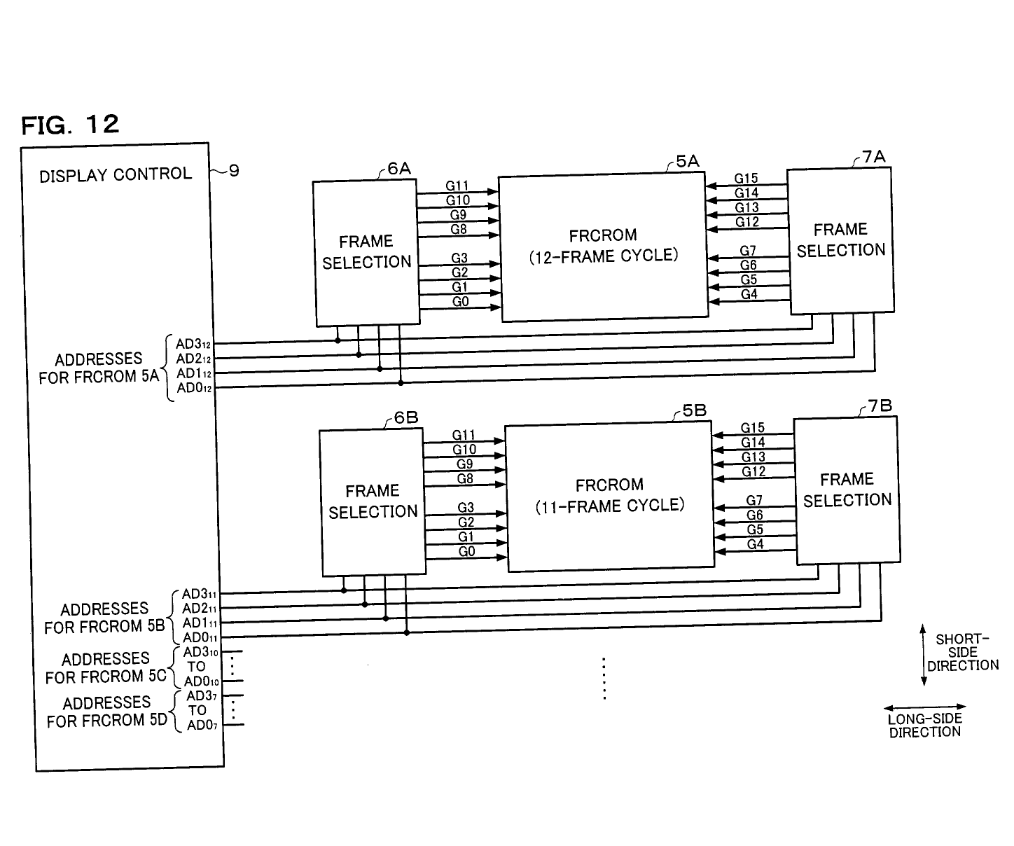

The connective relationships between the FRCROMs, frame selection circuits, and display control circuit is shown schematically in FIG. 12.

The FRCROM 5A decodes and outputs a grayscale pattern indicating display on/off, in accordance with the frame number specified by the frame selection circuit 6A or 7A, from among the grayscale patterns selected by the grayscale pattern selection signals that were output from the grayscale pattern selection ROM 4A.

The FRCROM 5B decodes and outputs a grayscale pattern indicating display on/off, in accordance with the frame number specified by the frame selection circuit 6B or 7B, from among the grayscale patterns selected by the grayscale pattern selection signals that were output from the grayscale pattern selection ROM 4B.

The FRCROM 5C decodes and outputs a grayscale pattern indicating display on/off, in accordance with the frame number specified by the frame selection circuit 6C or 7C, from among the grayscale patterns selected by the grayscale pattern selection signals that were output from the grayscale pattern selection ROM 4C.

The FRCROM 5D decodes and outputs a grayscale pattern indicating display on/off, in accordance with the frame number specified by the frame selection circuit 6D or 7D, from among the grayscale patterns selected by the grayscale pattern selection signals that were output from the grayscale pattern selection ROM 4D.

Of control signals G11 to G10 (control signals G15 to G12 are not used), control signals G11 to G8 and G3 to G0, which are input to the FRCROMs 5A to 5D for specifying individual frames, are generated in the frame selection circuits 6A to 6D. The control signals G15 to G12 and G7 to G4 are generated in the frame selection circuits 7A to 7D.

In this manner, the division of the frame selection circuitry corresponding to the FRCROMs into two portions is because the included plurality of transistors having large surface areas operating at high speeds, which form components such as transfer gates and NAND circuits in the frame selection circuits, would increase the surface area if those transistors were concentrated in one location, making layout difficult.

If the number of components in the FRCROMs in particular is small in comparison with the frame selection circuits that output control signals to the FRCROMs, the form of layout of the frame selection circuits would increase the size of the driver IC 20 in the short-edge direction and thus reduce layout efficiency. By dividing the frame selection circuits, therefore, it becomes possible to keep the length in the short-edge direction short, even though the length in the long-edge direction of the driver IC 20 increases, enabling an improvement in layout efficiency.

The description now turns to the frame selection circuits, grayscale pattern selection circuits, and FRCROMs.

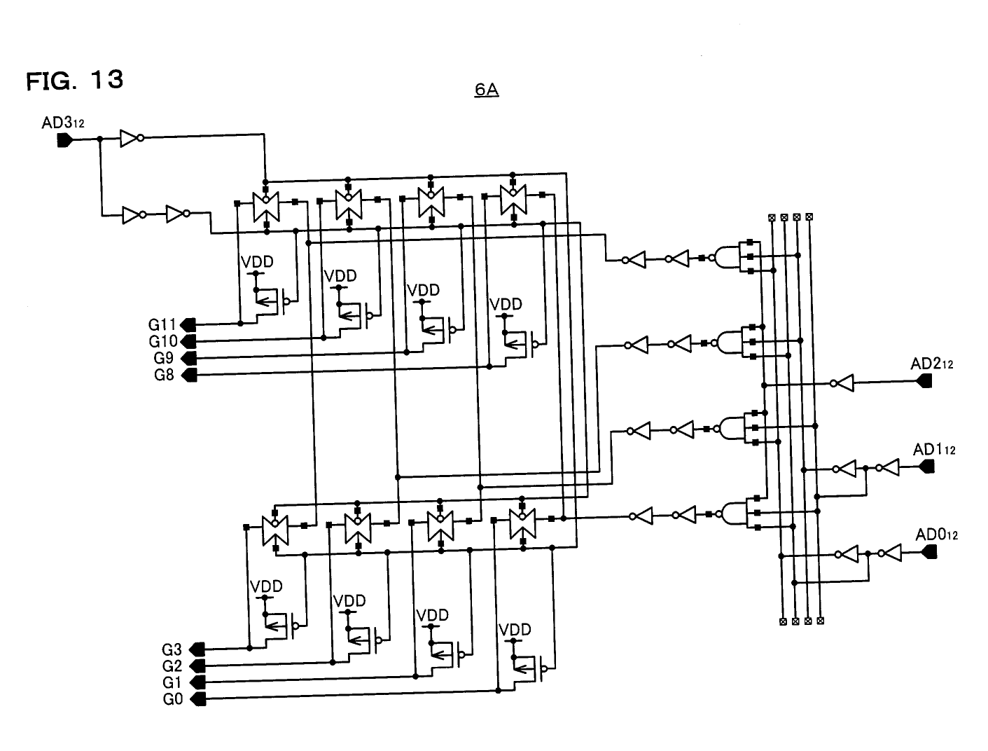

The frame selection circuit 6A generates the control signals G11 to G8 and G3 to G0 from the address signals AD3₁₂ to AD0₁₂ from the display control circuit 9, as shown in FIG. 13. The control signals G11 to G8 and G3 to G0 are output for the FRCROM 5A. The frame selection circuit 6A performs decoding in such a manner that the control signal G0 goes active (logic level goes low) and the control signals G11 to G8 and G3 to G1 go inactive (logic level goes high) when the address signals AD3₁₂ to AD0₁₂ indicate frame 1 (AD3₁₂ to AD0₁₂ =“0000”), by way of example. The frame selection circuit 6A also performs decoding in such a manner that the control signal G11 goes active (logic level goes low) and the control signals G10 to G8 and G3 to G1 go inactive (logic level goes high) when the address signals AD3₁₂ to AD0₁₂ indicate frame 12 (AD3₁₂ to AD0₁₂=“1011”), by way of example.

In this case, the description concerned the frame selection circuit 6A, but the frame selection circuits 6B to 6D and 7A to 7D have similar configurations so further description thereof is omitted.

The configuration could also be such that each of the grayscale pattern selection ROMs 4A to 4D and the corresponding one of the FRCROMs 5A to 5D are configured as a single ROM.

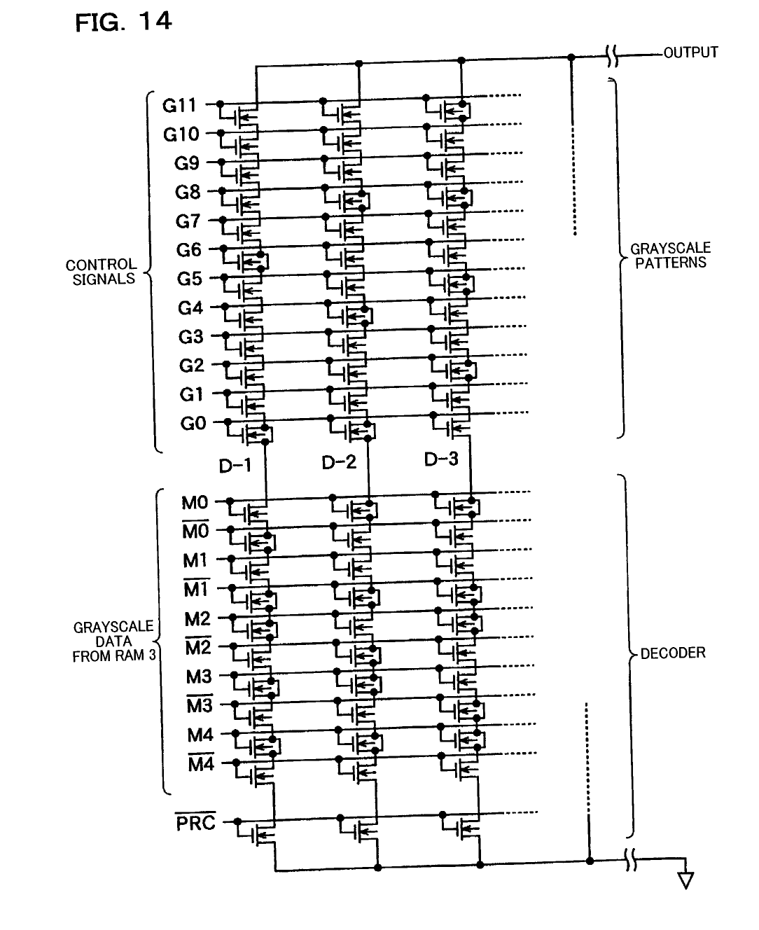

FIG. 14 shows an example in which each of the grayscale pattern selection ROMs 4A to 4D and the corresponding one of the FRCROMs 5A to 5D are configured as a single ROM.

When a grayscale pattern is output for a plurality of lines by a multi-line drive method (Multi Line Selection: MLS), in which a plurality of common electrodes is selected simultaneously, with a ROM of such a configuration, a plurality of segment electrodes corresponding to that plurality of common electrodes are used as odd-numbered lines and even-numbered lines, so two ROMs are paired. If the grayscale pattern selection ROM 4A is configured together with the corresponding FRCROM 5A as a single ROM, the ROM comprises two parts as shown in FIG. 14.

A predetermined number of the plurality of transistors shown in FIG. 14 are short-circuited between source and drain by aluminum wiring, to store an algorithm used in the conversion of data thereby.

The lower-side transistor group forms a grayscale pattern selection ROM (decoder) for selecting a grayscale pattern based on the 5-bit grayscale data supplied from the RAM 3, and sends a grayscale pattern selection signal corresponding to the 5-bit grayscale data to the upper-side transistor group. The upper-side transistor group represents the grayscale patterns D-1, D-2, D-3, . . . shown in FIG. 7. If grayscale data (M4 to M0=“00011”) is input, by way of example, the grayscale pattern D-1 represented by the array of transistors on the leftmost side is selected. In that case, the grayscale pattern selection signal applied to the source of the transistor whose gate is connected to the control signal G0, of the array of transistors on the leftmost side, is set to the ground potential (precharger potential).

The control signals G0 to G11 are applied to the gates of the upper-side transistor group. The source and drain are short-circuited in the transistor corresponding to the first control signal G0 and the transistor corresponding to the seventh control signal G6, in the array of transistors on the leftmost side that represent the grayscale pattern D-1. The dots that represent the uppermost row of the grayscale pattern D-1 shown in FIG. 7 are output sequentially by making the logic levels of the control signals G0 to G11 go low in sequence while the logic levels of the other signals remain high. Similarly, it is possible to represent all of the 32 grayscales shown in FIGS. 8 and 9 by providing ROMs that comprise transistor groups corresponding to the other grayscale patterns A to C.

In FIG. 1, the outputs for odd-numbered lines and even-numbered lines, which are output from ROM of the configuration shown in FIG. 14, are input to the LCD interface 8.

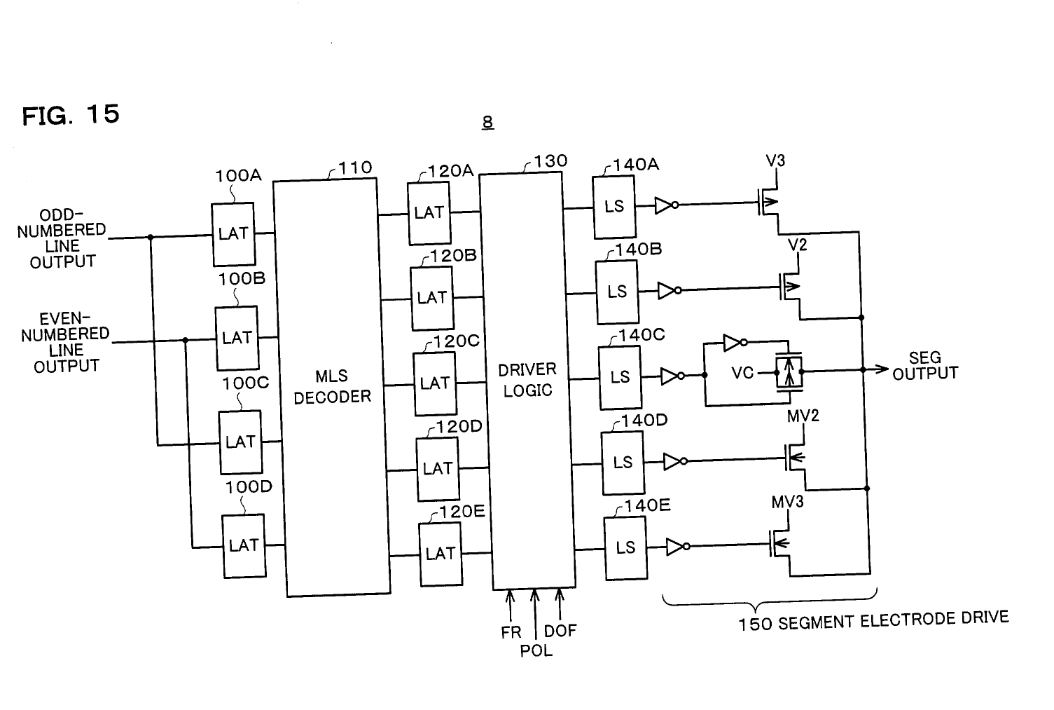

An example of the configuration of the LCD interface 8 is shown in FIG. 15.

This example shows the configuration for the output for one segment driven by MLS, where four lines are selected simultaneously.

The LCD interface (generally speaking: a drive signal output circuit) 8 comprises latch circuits 100A to 100D, a MLS decoder 110, latch circuits 120A to 120E, a driver logic 130, level shifters (LS) 140A to 140E, and a segment electrode drive circuit 150.

The latch circuit 100A latches the output for the first line corresponding to the common electrodes for four lines that are selected simultaneously by MLS, of the odd-numbered lines from the FRCROMs 5A to 5D. The latch circuit 100C latches the output for the third line corresponding to the common electrodes for four lines that are selected simultaneously by MLS, of the odd-numbered lines from the FRCROMs 5A to 5D. The latch circuit 100B latches the output for the second line corresponding to the common electrodes for four lines that are selected simultaneously by MLS, of the even-numbered lines from the FRCROMs 5A to 5D. The latch circuit 100D latches the output for the fourth line corresponding to the common electrodes for four lines that are selected simultaneously by MLS, of the even-numbered lines from the FRCROMs 5A to 5D.

The MLS decoder 110 uses an orthogonal function stipulated by the scan pattern for four lines of common electrodes that are selected simultaneously, to perform a previously set MLS computation on the display pattern for four lines of segment electrodes (the abovementioned first to fourth lines), then decodes the result of that computation for output in field units. This decoded output is output as a selection signal that selects the voltage supplied to each segment electrode. With four-line simultaneous selection, this selection signal is any one of five voltages (V3, V2, VC, MV2, MV3).

The decoded output that is output from the MLS decoder 110 is input to the driver logic 130 after being latched by the latch circuits 120A to 120E.

The driver logic 130 performs a logical operation on the selection signal in accordance with factors such as polarity inversion timing. The output of the driver logic 130 is input to the segment electrode drive circuit 150 after the voltage level thereof has been converted by the level shifters 140A to 140E. The segment electrode drive circuit 150 outputs one of the voltages V3, V2, VC, MV2, and MV3 through the segment output terminal to the segment electrodes of the LCD panel 30, based on the level shifters 140A to 140E.

The above described configuration selects one grayscale pattern from a plurality of grayscale patterns having mutually different frame cycles, based on 5-bit grayscale data for each color that has been converted from 4-bit image data for each color from the MPU 10, making it possible to output drive signals to segment electrodes for driving the LCD panel (generally speaking: a display panel) 30 by a method such as MLS.

This driver IC 20 can be provided on a substrate on which the LCD panel 30 is mounted, where the LCD panel 30 comprised pixels that are defined by a plurality of common electrodes and a plurality of segment electrodes, which mutually intersect. The scan driver that drives the common electrodes of the LCD panel 30 could also be provided on that substrate.

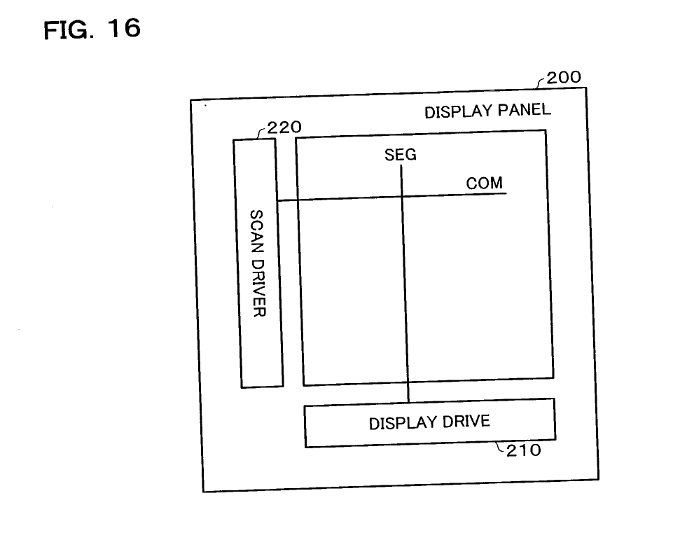

If a display panel 200 comprising pixels defined by a plurality of common electrodes and a plurality of segment electrodes, which mutually intersect, is formed on a glass substrate, a display drive circuit 210 in accordance with this embodiment that has functions similar to those of the driver IC 20 could be formed directly on that glass substrate, without being integrated, as shown in FIG. 16. In such a case, the configuration could be such that the common electrodes of the display panel 200 are driven by a scan driver IC outside of the display panel 200, or a scan driver 220 for driving the common electrodes of the display panel 200 could be formed directly on the same glass electrode.

Note that the present invention is not limited to the above described embodiments thereof, and thus various modifications thereto could be envisioned.

As described above, these embodiments of the present invention make it possible to broaden the types of colors that can be displayed and increase the degree of freedom of the selection of colors displayed, when driving an LCD or the like to display color in a plurality of grayscales.

What is claimed is:

1. A display drive circuit comprising:
RAM which sequentially stores data for image display that is input continuously;
a plurality of grayscale pattern selection circuits, each selecting one grayscale pattern from a plurality of grayscale patterns, based on data stored in the RAM; and
a plurality of frame selection circuits which are provided in correspondence with the plurality of grayscale pattern selection circuits, and sequentially output grayscale patterns selected by the plurality of grayscale pattern selection circuits for a series of image frames.

2. The display drive circuit as defined in claim 1, further comprising:
an image data conversion circuit which receives data in which grayscales are represented by N bits (where N is an integer greater than or equal to 2), converts the received data into data in which grayscales are represented by M bits (where M is an integer such that M>N), based on a set command, and supplies the converted data to the RAM.

3. The display drive circuit as defined in claim 1, wherein each of the plurality of grayscale pattern selection circuits includes:
a selection ROM which outputs a grayscale pattern selection signal based on data stored in the RAM; and
an FRCROM which selects one grayscale pattern from among the plurality of grayscale patterns in accordance with the outputted grayscale pattern selection signal, and uses the selected grayscale pattern to perform frame rate control (FRC) modulation in accordance with a control signal that is output from the corresponding frame selection circuit.

4. The display drive circuit as defined in claim 2, wherein each of the plurality of grayscale pattern selection circuits includes:
a selection ROM which outputs a grayscale pattern selection signal based on data stored in the RAM; and
an FRCROM which selects one grayscale pattern from among the plurality of grayscale patterns in accordance with the outputted grayscale pattern selection signal, and uses the selected grayscale pattern to perform frame rate control (FRC) modulation in accordance with a control signal that is output from the corresponding frame selection circuit.

5. The display drive circuit as defined in claim 1,
wherein each of the frame selection circuits is divided into a plurality of portions that are disposed on either side of the corresponding grayscale pattern selection circuit.

6. A display drive circuit comprising:
RAM which sequentially stores data for image display that is input continuously;
a plurality of FRCROMs which store a plurality of grayscale patterns with mutually different frame cycles, and use data stored in the RAM to select one grayscale pattern from among the plurality of grayscale patterns; and
a plurality of frame selection circuits each of which sequentially outputs the selected grayscale pattern selected by the FRCROMs, for each frame,
wherein a drive signal for driving a display portion is output based on the outputted grayscale pattern from the FRCROMs.

7. The display drive circuit as defined in claim 6, further comprising:
an image data conversion circuit which receives data in which grayscales are represented by N bits (where N is an integer greater than or equal to 2), converts the received data into data in which grayscales are represented by M bits (where M is an arbitrarily settable integer such that M>N), and supplies the converted data to the RAM,
wherein each of the frame selection circuits outputs the selected grayscale pattern based on the M-bit grayscales, for each frame.

8. A semiconductor integrated circuit comprising:
the display drive circuit as defined in claim 1; and
a terminal which outputs a drive signal generated on the basis of the selected grayscale pattern.

9. A semiconductor integrated circuit comprising:
the display drive circuit as defined in claim 2; and
a terminal which outputs a drive signal generated on the basis of the selected grayscale pattern.

10. A semiconductor integrated circuit comprising:
the display drive circuit as defined in claim 3; and
a terminal which outputs a drive signal generated on the basis of the selected grayscale pattern.

11. A semiconductor integrated circuit comprising:
the display drive circuit as defined in claim 4; and
a terminal which outputs a drive signal generated on the basis of the selected grayscale pattern.

12. A semiconductor integrated circuit comprising:
the display drive circuit as defined in claim 5; and
a terminal which outputs a drive signal generated on the basis of the selected grayscale pattern.

13. A semiconductor integrated circuit comprising:
the display drive circuit as defined in claim 6; and
a terminal which outputs a drive signal generated on the basis of the selected grayscale pattern.

14. A display panel comprising:
pixels specified by a plurality of common electrodes and a plurality of segment electrodes, which mutually intersect; and
the display drive circuit as defined in claim 1, which drives the segment electrodes.

15. A display panel comprising:
pixels specified by a plurality of common electrodes and a plurality of segment electrodes, which mutually intersect; and
the display drive circuit as defined in claim 2, which drives the segment electrodes.

16. A display panel comprising:
pixels specified by a plurality of common electrodes and a plurality of segment electrodes, which mutually intersect; and
the display drive circuit as defined in claim 3, which drives the segment electrodes.

17. A display panel comprising:
pixels specified by a plurality of common electrodes and a plurality of segment electrodes, which mutually intersect; and
the display drive circuit as defined in claim 4, which drives the segment electrodes.

18. A display panel comprising:
pixels specified by a plurality of common electrodes and a plurality of segment electrodes, which mutually intersect; and
the display drive circuit as defined in claim 5, which drives the segment electrodes.

19. A display panel comprising:
pixels specified by a plurality of common electrodes and a plurality of segment electrodes, which mutually intersect; and
the display drive circuit as defined in claim 6, which drives the segment electrodes.

20. A display drive method comprising:
selecting one grayscale pattern from among a plurality of grayscale patterns having at least two types of frame cycles, based on data for image display, and outputting the selected grayscale pattern for each frame; and
outputting a drive signal for driving a display portion, based on the selected grayscale pattern.

21. The display drive method as defined in claim 20,
converting grayscales of N bits (where N is an integer greater than or equal to 2) into grayscales of M bits (where M is an arbitrarily settable integer such that M>N); and
selecting one grayscale pattern from among the plurality of grayscale patterns having at least two types of frame cycles, based on the M-bit grayscales, and outputting the selected grayscale pattern for each frame.
